(19) United States
(12) Patent Application Publication
(10) Pub. No.: US 2009/0106604 A1
(43) Pub. Date: Apr. 23, 2009

(54) Procedure and device for emulating a programmable unit

(76) Inventors: Alexander Lange, Strasslach (DE); Alexander Weiss, Flintsbach (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/919,696

(22) PCT Filed: May 2, 2006
(86) PCT No.: PCT/EP2006/061986

§ 371 Date: Oct. 30, 2007

(30) Foreign Application Priority Data
May 2, 2005 (EP) 05009621.3

(51) Int. Cl. G06F 11/26

(52) U.S. Cl. 714/45; 714/E11.199; 714/E11.168; 714/E11.216; 714/E11.212

(57) ABSTRACT

The invention concerns a procedure and a device for emulating a programmable unit using an external emulation device. The method comprises transferring a signal to the external emulation device, which allows deriving the original CPU clock signal of the target programmable unit, and, in a defined relationship with the CPU clock signal (8), emulation data, which are formed by those data, which cannot be calculated on the basis of a given model of the target programmable unit and on the basis of the program code. The target programmable unit is emulated by the external emulation device (1) using the transferred emulation data, and respective trace data are ascertained from the emulation. The invention further concerns an apparatus for emulation, comprising a target programmable unit, which has at least one CPU, and comprising an emulation device, which, as an external unit (14), is connected via an emulation port as a communication link with the target programmable unit. Finally, the invention concerns a programmable unit.

### CROSS REFERENCE TO RELATED APPLICATIONS

This application is for entry into the U.S. national phase under §371 for International Application No. PCT/EP2006/061986 having an international filing date of May 2, 2006, and from which priority is claimed under all applicable sections of Title 35 of the United States Code including, but not limited to, Sections 120, 363 and 365(c), and which in turn claims priority under 35 USC §119 to EP Patent Application No. 05 009 621.3 filed on May 2, 2005.

### BACKGROUND OF THE INVENTION

1. Technical Field

The invention concerns a procedure and a device for emulating a programmable unit. The invention further concerns an apparatus for emulation, comprising a target programmable unit, which has at least one CPU, and comprising an emulation device, which, as an external unit, is connected via an emulation port as a communication link with the target programmable unit. Finally, the invention concerns a programmable unit.

2. Discussion of Related Art

A programmable unit is hereunder also referred to as “PU”, “target programmable unit” or “target PU”. The programmable unit may be a processor, microcontroller, signal processor or other similar device. A programmable unit contains at least one central processing unit, hereunder referred to as “CPU” or “target CPU”, that can include an instruction decoder, an instruction fetch, an register memory, an arithmetic logic unit (ALU) and/or a pipeline.

The programmable unit, PU, can normally include memory that is directly assigned to the CPU, which is referred to as register memory. This register memory can be divided into a number of blocks that are referred to in the following as “register banks”. Various program parts, such as the main program, subprograms or event routines can now be exclusively assigned to a register bank respectively. All parts of the program exclusively assigned to a register bank are referred to in the following as “context”.

A copy of the register memory in part or complete will be referred to as “register memory copy” in the following.

The programmable unit also normally includes various lines such as data lines, address lines or control lines, which are normally run as a bus and transfer addresses, data, control signals and other related items within the programmable unit as well as to interfacing devices if required.

Besides one or more CPUs, the PU can contain one or more units that have write-access to the memory, such as a DMA controller (Direct Memory Access) for example. These units will be referred to as “DMA unit” in the following.

Besides the one or more CPUs, the PU can also contain one or more units that control memory management, such as an MMU (Memory Management Unit) for example. These units will be referred to as “MMU unit” in the following.

The programmable unit can also contain one or more peripheral units such as timers, analog/digital converters and UARTs (Universal Asynchronous Receiver Transmitter). These peripheral units are referred to hereinafter as “On-Chip Peripherals.”

In this programmable unit, programs run in order to process data or to transfer instructions to external devices. Emulators have been developed for observing and, if necessary, changing internal states and processes during normal operation of the programmable unit.

Corresponding information about run-time behavior of such a program during an application under real-time conditions is a very important part of quality assurance and error analysis. The addresses, data, control signals, states, events and similar items processed or used within the programmable unit are hereinafter referred to as “trace data”.

In such a trace data set, all of the processor instructions executed by the programmable unit and, to a partial extent, read and write operations, are captured and, if necessary, labeled with a time identification mark, a so-called time-stamp. The trace data analyzes code coverage and the time behavior of functions and procedures (performance analysis).

So-called emulators or emulation devices are used to acquire the respective trace data.

In order to make analysis of the behavior of the programmable unit possible later, the following information is normally required:
data that is read (load)
data that is written (store)
branches made (branch)
context change based on interrupts

There are mainly two methods known from practice for acquiring such trace data.

One method is referred to as the so-called in-circuit emulator (ICE) with bond-out chip. The so-called bond-out chip is integrated within this ICE and the bond-out chip basically works like the programmable unit but offers additional accesses to the internal buses and several additional registers. The ICE receives the required trace data from these internal buses.

From U.S. Pat. No. 5,515,530, for instance, an in-circuit-emulator is provided as a part of an integrated circuit, which has two modes of operation. A first mode, which is used for real-time event evaluation, and a second mode of acquiring register data to communicate to an external emulation device.

In a target system, in which, ultimately, the programmable unit is supposed to work, this target PU is normally removed from its support fixture and the corresponding emulation device connected directly or via a ribbon cable. The emulation device is normally a circuit board with a processor of the same type as the target CPU, normally in a bond-out version. In addition, buffer memory and interface logic is present on the emulator side.

Using this method, all activities of the processor can be recorded in real-time.

However, the required space requirements are relatively high and, at higher frequencies, the respective emulation device cannot be implemented or at least only at great expense. The cabling is also relatively complex so that high total costs are incurred. Since the actual programmable unit is replaced by the emulation device, it cannot be used in the target system, but, instead, must be replaced by the respective programmable unit again later on.

Another technique is referred to as “on-chip trace port” and is another method of acquiring trace data. This requires the implementation of minimum functionality for acquiring trace data on the programmable unit directly. This is supplemented by a memory and other components, such as a logic unit and similar items to enable the recording of internal bus signals in real-time (trace macro cell).

The data that is acquired in this way can, for example, be made available using a JTAG interface (JTAG=Joint Test Access Group) or an OCDS module (on-chip debug support module) and a special trace port.

The trace port is implemented in the programmable unit and connected internally with the data bus and the control bus. The trace port requires far fewer pins in comparison with a bond-out chip. However, in practice the real-time trace capabilities are limited by the bandwidth of the trace port and full recording of all activities of the programmable unit is only possible at very high cost. Therefore, normally only limited trace data is made available.

EP 1 139 220 A2 described an integrated circuit and an external emulation controller. Digital bits representing an internal clock cycle of a target CPU are forwarded to the emulation controller at an output clock rate that differs from the clock rate of the internal clock. An on-chip debugging environment is provided. A disadvantage of this system is the high transmission bandwidth required between the integrated circuit and the external emulation controller.

It is therefore an object of the present invention to improve the procedures and device for the emulation of a programmable unit in such a manner that inexpensively enables acquiring trace data with a reduced transmission bandwidth between the programmable unit and the emulation device while retaining the respective advantages of known trace methods.

### DISCLOSURE OF INVENTION

According to a first aspect of the invention, a method for emulation of a target programmable unit, which has at least one CPU, by means of an external emulation device is provided, which external emulation device is coupled to the target programmable unit by means of a communication link. The method comprises the following steps:
Transferring predetermined initialization data through the communication link to the emulation device, with which initialization data the target programmable unit has initialized itself and/or has been initialized, for initializing the emulation;
Transferring through the communication link to the emulation device, a CPU clock signal of the target programmable unit (1) and, in a defined relationship with the CPU clock signal:
   data read by the CPU from a data bus of the target programmable unit,
   those external events that have an influence on the program counter,
   optionally, events that trigger a data transfer bypassing the CPU,
   optionally, periodically created complete or partial copies of the register memory, and,
   optionally, one or more data type signals;
Emulating the target programmable unit in the external emulation device using the transferred emulation data;
Ascertaining respective trace data from the emulation in the external emulation device; and
Storing and/or the outputting the trace data.

The fundamental idea behind the method of the first aspect of the invention is that the desired trace data is not taken from the target CPU directly but is determined and made available by a replication of this target CPU by an external and separate emulation device (ED). The method of the invention unfolds particular advantages in debugging applications if mass produced chips of target programmable units are equipped with a facility that allows the synchronization with an external emulator according to the method of the invention.

An important effect achieved with the method of the present invention is that the bandwidth for transmitting the emulation data to the emulation device during emulation is narrower than the bandwidth that is required for outputting a complete set of trace data from the CPU. This also results in a considerable reduction in effort for implementing the data output from the target programmable unit, leading to its lessened cost.

Only a small amount of data needs to be communicated from the target CPU to the emulator according to the invention, namely, data that is required to reconstruct all internal data and the program flow. All other system responses are defined by the program code. Conventional methods transfer all read data and write data as well as all jumps to the emulator. In contrast, the method of the invention requires transfer of only a limited set of data:
data read by the CPU from a data bus of the target programmable unit,
   those external events that have an influence on the program counter, such as interrupts that have occurred or events that stop the CPU,
   optionally, periodically created complete or partial copies of the register memory, and,
   optionally, one or more data type signals.

In addition, the CPU clock signal, either in the form of the actual CPU clock signal or, more generally, in the form of a signal, which allows to derive the original CPU clock signal of the target programmable unit, is transferred to the emulation device.

In summary, only those data are transferred, which cannot be calculated on the basis of a given model of the target programmable unit and on the basis of the program code. In one embodiment, it suffices to transfer all data read by the CPU from a data bus of the target programmable unit, and the interrupts because only this data/these events can change the program flow unpredictably. In another embodiment, additional events are transferred from the target programmable unit to the emulation device, for instance those events which trigger a DMA transfer.

The execution of this program in the target CPU is determined by known data such as the program code at the time of the program start and by further data and events becoming known during program execution.

The events that have influence on the program counter, such as interrupts that have occurred or events that stop the CPU and events that trigger a data transfer bypassing the CPU (DMA transfer) are hereinafter also summarized under the term event data.

Data marked as optionally transferred are in specific embodiments transferred in addition to those data not marked as optional. Such embodiments will be described further below.

All required and optional data mentioned in the above list of transferred data according to the invention are in the present description also summarized under the term emulation data.

The emulation thus reproduces the behavior of the CPU. In order to do so, the emulation is initialized with a known state, for example, of the target CPU, whereby this state can also be a reset. This means that the ED receives data from the CPU by means of which the emulation can be put into a state that completely or partially corresponds with the state of the CPU. This data is referred to hereinafter as initialization data.

Starting from the initial state and a previously conveyed program code, the emulation data and the CPU clock is transmitted to the emulation device during the runtime of the program. The external emulation is therefore capable of emulating the program execution of the CPU. During this emulation, the emulation device can make a complete or partial set of trace data accessible.

The following table visualizes the reduced set of data transferred between the target PU and the emulation device, which set of data suffices for an emulation in the method of the present invention, in comparison to prior art solutions:

TABLE 1
Comparison of required output from target PU

| | | Required output from target PU | |
|---|---|---|---|
| | | “normal” | |
| Instruction type | Frequency | embedded trace | present invention |
| Load (RAM) | 20% | required | not required |
| Load (IO) | 5% | required | required |
| Store | 10% | required | not required |
| ALU instructions | 45% | not required | not required |
| Branch | 15% | required | not required |
| Jump | 5% | required | not required |
| Interrupts | near 0% | required | required |
| Frequency Total | 100% | 55% | 5% |

The information on frequency of the respective instruction types in the above table is based on information provided by the book David Patterson, John Hennessy: Computer Organization and Design, Third Edition, Elsevier 2005.

The interface of the programmable unit for communicating with the emulation device is referred to hereinafter as emulation port. Another term for it with equal meaning is “trace port”.

In the following, preferred embodiments of the method of the invention will be described. Unless stated otherwise explicitly, embodiments can be combined with each other.

In one preferred embodiment, the CPU clock signal is transmitted from the target programmable unit through an emulation port to the emulation device. This way, the emulation device is enabled to assign time information to all incoming emulation data, for instance in the form of a time stamp. The transfer of the CPU clock signal through the emulation further allows clock-synchronous transfer of the data for synchronization in view of possible changes of the CPU clock by variations in the clock oscillator of controlled switching between different CPU clock frequencies.

In a preferred embodiment, the transfer of data between the target programmable unit and the external emulation device is reduced to a minimum. Here, the step of transferring the emulation data comprises transferring exclusively:
data read by the CPU from a data bus of the target programmable unit,
those external events that have an influence on the program counter,
optionally, periodically created complete or partial copies of the register memory, and,
optionally, one or more data type signals.

That means, in one embodiment, the transfer of emulation data is reduced to data read by the CPU from a data bus of the target programmable unit, and those external events that have an influence on the program counter. In another embodiment, periodically created complete or partial copies of the register memory are additionally transferred. In yet another embodiment, one or more data type signals are transferred, either in addition also to a respective copy of a register memory or only in addition to the initially mentioned read data and external events. The emulation data marked as optional are thus transferred in specific embodiments, which will be explained further below.

In a further embodiment, the emulation is performed as of receiving a quantity of data from the target programmable unit. The mentioned quantity of data serves for initializing the emulation with a known state of the target CPU. It is a prerequisite that the emulation uses identical program code, which preferably forms a part of the quantity of data received from the target programmable unit. However, the program code and the further data defining the known state of the target CPU can be provided at different times. When, in the following emulation procedure, the emulation receives the emulation data and CPU clock, it is able to ascertain identical input data for the emulation as for the target CPU, and the state of the emulation corresponds exactly to the state of the target CPU. The emulation thus delivers trace information, which is identical to those, that could be recorded directly from the target CPU.

In order to decrease the required number of connections on the emulation port during data transmission, all signals mentioned can also be combined by time/space and possibly further compressed by other procedures. This and the following more specific examples can also be initiated in each case by the emulation device. In one example, the CPU clock signals are transferred to an emulation controller of the programmable unit and/or to a buffer memory of the target programmable unit. This allows transferring the emulation data to the emulation in a defined relation to the CPU clock signal. The “term emulation” controller is used herein with the same as the term “trace controller”.

In particular, in alternative embodiments the emulation data is transferred with either falling edges or rising edges of the CPU clock signal, or with falling as well as with rising edges of the CPU clock signal. In the latter embodiment the emulation data is transferred with a doubled data rate, which further increases speed. In a further example, a frequency of a clock signal driving the transfer of the emulation data is increased over the CPU clock frequency during transfer of the emulation data. This embodiment forms another way of accelerating the transfer of the emulation data. The frequency of the clock signal driving the transfer of the emulation data can be a multiple of the CPU clock signal frequency. Preferably, the transfer of the emulation data is performed in synchrony with the CPU clock signal. The CPU clock signal can also be transferred via a separate data line, which will be explained in detail further below in the context of an embodiment employing a LVDS Serdes interface.

In another embodiment, the emulation data to be transferred is distributed over several cycles of the target CPU.

The target programmable unit is in one embodiment switched to an operating mode for using a emulation port, which is configured as a part of the communication link of the target programmable unit, as a standard I/O port, specifically, as an output port. In this embodiment, the advantage of requiring a smaller bandwidth for transfer of emulation data and the CPU clock according to the invention is exploited in an additional use of the remaining transfer capacity of the emulation port for standard output tasks of the target programmable unit. In order to be able to utilize the emulation port via the programmable unit in another context, the programmable unit can switch the emulation port to an operating mode for use also as a general output port. This can be accomplished by setting a special mode pin or by setting a bit in a control register within the programmable unit.

Preferably, the emulation port of the target CPU and of the emulation device are operated in a bi-directional operating mode and thus allow not only transfer of emulation data and the CPU clock to the emulation device, but also controlling the target CPU by the emulation device. This functionality is in some prior-art devices provided by JTAG interfaces. However, the present embodiment allows a sharing of the same pins by the emulation port and the JTAG interface, which reduces area consumption on a chip. The present embodiment further allows an insertion of CPU wait cycles to be controlled not only by the target programmable unit, but also by the emulation device while the emulation data and the CPU clock is being transferred. Also, a check of the programmable unit is possible with the emulation device as well. In this case, a debugger can access the address area of the CPU via the emulation device and can perform read and write operations, as the case may be. These operations include reading and writing to RAM and I/O ranges, setting breakpoints or other similar operations. Setting a breakpoint is a method during which the CPU is instructed to pause the program as soon as a pre-defined condition is met, for example reaching a certain part of the program executed.

The emulation data and the CPU clock can be transferred to the emulation device via one common signal path only. Between the programmable unit and the emulation device, the respective communication can take place via a serial point-to-point connection, for example a serializing/deserializing, low voltage differential point-to-point connection (LVDS Serdes). It is noted that the LVDS Serdes connection needs a constant clock frequency provided to the interface. In view of possible sudden changes of the CPU clock mentioned earlier, one embodiment of the present invention comprises providing an external clock signal of a frequency higher than the CPU clock frequency to a LVDS Serdes interface. Preferably, in this embodiment, the CPU clock is transferred via a normal data line and can be used at the receiving end.

In another embodiment, the method comprises a step of filtering the determined the trace data before output and/or saving by means of the emulation device. Filtering can be performed according to pre-defined criteria according to the needs of the particular emulation process.

In the following, four main groups of embodiments will be presented. A first main group concerns offline emulation without emulating a RAM of the target programmable unit. A second main group concerns offline emulation including emulating a RAM of the target programmable unit. A third main group of embodiments concerns real-time emulation without emulating a RAM of the target programmable unit. And, finally, a fourth main group concerns real-time emulation including emulation of a RAM of the target programmable unit.

In the first main group of embodiments, the emulation of the target programmable unit is performed offline by the emulation device, using previously obtained and stored emulation data. In this embodiment, preferably, the CPU clock signals received from the target programmable unit are counted in the emulation device with a counting device for assigning a certain point in time (time stamp) to the transferred emulation data. In this embodiment, the copy (“snapshot”) of the register memory, is transferred as a part of the emulation data and allows, together with the other mentioned emulation data and the CPU clock, a complete imitation of the instructions of the target CPU in the emulation device.

The offline emulation of the target programmable unit can be performed either with or without emulating a random access memory (RAM) of the target programmable unit.

When performing an offline emulation without emulating the RAM of the target programmable unit, the program execution of the target programmable unit is preferably simulated by the emulation device for each respective context level beginning at the time of the last detected, complete copy of a register bank of the same context. It is thus not necessary for the emulation device to detect the complete program flow of the target CPU. The different context levels can be performed for each respective context level. The emulation can thus be initialized with the register memory copy and started for a context, for which a register memory copy exists, as of the time that the register memory copy was created.

To begin the emulation at a point in time that is later than the program start, the programmable unit must indicate to the emulation device the CPU's status at such later point in time. To this end, the programmable unit can store the current content of the register memory or individual register banks, which is referred to hereinafter as register memory copy. This register memory copy can then be transferred as part of the emulation data to the emulation device. If the register memory copy is completely output, a new copy of the register memory or individual register banks, preferentially the current register bank is read in and then output again, etc. Using register memory copies captured after a program start, in accordance with the invention, it becomes possible to allow a simulation to skip over portions of CPU program execution, thereby allowing the simulation for each context level to be started at the time of the last complete captured copy of the register bank assigned to the relevant context.

Since timing requirements are relaxed for an offline emulation, the CPU of the target programmable unit is in one embodiment emulated by means of a computer program, which is executed on a computer. This relaxes hardware requirements and reduces the cost of the emulation.

The second main group of embodiments includes emulating a part of the RAM of the target programmable unit during offline emulation of the target programmable unit.

The advantage of this embodiment is a further reduced transfer of emulation data, which now is restricted to data read from memory areas that are used in a non-exclusive manner used by the target CPU. Examples of such memory areas are I/O areas or dual-ported RAMs.

This embodiment preferably comprises the steps of
determining in the target programmable unit whether data currently read by the CPU or during a DMA operation originate from an address of the target programmable unit that can be written to by function units other than the CPU of the target programmable unit, followed by
transfer of only those data read by the CPU or during a DMA operation to the emulation device, which originate from the address range of the target programmable unit that can be written to by function units other than the CPU of the target programmable unit.

In alternative forms of this embodiment, the address ranges that can be written to by function units other than the CPU of the target programmable unit are either permanently preprogrammed in a fixed way or configured freely or partly programmed permanently and partly configured freely. The first case is useful for I/O-areas, while the second case is suitable for external dual-ported RAM.

For including a RAM emulation it is required to include all function units in the CPU emulation, which have write access to the RAM. Especially, the CPU and the DMA controller have write access to the RAM.

In the following, common embodiments of the third and fourth main groups of embodiments are explained.

When performing a real-time emulation of the target programmable unit in the emulation device, the emulation is preferably implemented in a programmable logic module of the emulation device, for instance a field programmable gate array, or using a bond-out-chip. Both can be configured to emulate the functionality of the target CPU and to provide the trace data at their output.

A particular advantage of the real-time emulation is that the emulation device does not have to contain any on-chip peripherals that are normally implemented on bond-out-chips. Currently, a large number of bond-out-chips is required for emulating and debugging the various on-chip peripherals for a given CPU core of the programmable unit. Current microprocessor series require up to about 20 different bond-out chips.

Since, for use with the present embodiment, a bond-out chip does not have to be produced with different peripherals for every microcontroller family, it is now sufficient to have a single bond-out chip for a respective implementation in the programmable logic module for supporting all members of the respective microcontroller family. Thus, a single emulation device can be used for emulating multiple different implementation variants of a target programmable unit, namely, by loading the respective implementation of the real-time-emulation of the programmable unit into a programmable logic module.

For performing the real-time-emulation, the target CPU delivers the emulation data and the CPU clock to the emulation device. The emulation device ascertains the trace data, which then can be stored or filtered before storing, as mentioned before.

In one embodiment, the target programmable unit or the CPU of the target programmable unit is stopped by the emulation device or by the target programmable unit upon detecting a valid breakpoint. This allows implementing a mechanism for supporting complex breakpoints in the emulation device. The relevant information is available to the emulation device, and the additional capability of stopping the programmable unit and accessing the address and data bus of the programmable unit is achieved.

Preferably, one or more breakpoint is initiated and managed by the emulation device. In one embodiment, every breakpoint is initiated and managed by the emulation device. If a valid breakpoint is detected by the emulation device, the target CPU is halted. Access to the address and data bus of the programmable unit can take place through a suitable interface, for instance by using the emulation port. For very high CPU frequencies, additional measures might be required, which will be discussed further below.

Preferably, a breakpoint signal is transferred from the emulation controller (trace controller) of the target programmable unit, or from the emulation controller of the emulation device, to the CPU of the target programmable unit.

In a further embodiment providing a real-time emulation, the emulation device has write and read access to its memory and, in case of a read access, receives the data transfer from the target programmable unit.

If an interrupt is generated in the target programmable unit, the same interrupt is triggered in the emulation device either simultaneously or with a CPU clock offset.

According to a further embodiment, a data selector of the emulation device is switched to reading data from a memory device of the emulation device or to reading data received from the target programmable unit.

If the real-time emulation of the target programmable unit is performed without emulating RAM of the target programmable unit (third main group of embodiments), the following emulation data is transferred:
data read by the CPU from a data bus of the target programmable unit, and
those external events that have an influence on the program counter.

In contrast to the offline emulation case without emulation a RAM (first main group of embodiments), it is not required to transfer periodically created complete or partial copies of the register memory.

In a case where the real-time emulation of the target programmable unit includes emulating either a part of or the complete RAM of the target programmable unit in real time (fourth main group of embodiments), a complete or partial copy of at least one RAM of the target programmable unit is also run in the emulation device. This embodiment preferably includes emulating those function units of the target programmable unit, which write to the RAM of the target programmable unit.

For programmable units operated at very high CPU clock frequencies or with high CPU read bandwidth, it is advantageous to store the emulation data temporarily in a FIFO memory.

In case a breakpoint is triggered in the emulation device with an offset in comparison to the CPU of the programmable unit, the emulation device continues the emulation after the breakpoint using the emulation data stored in the FIFO memory up to the point, where the CPU of the target programmable unit was stopped by the emulation device. This embodiment keeps the emulation device in synchrony with a target programmable unit operated at very high CPU clock frequencies (frequency range of approximately 500 MHz and above) even in the case of a breakpoint.

According to a second aspect of the invention, an apparatus for emulation of a programmable unit is provided. The apparatus comprises a target programmable unit, which has at least one CPU, and an emulation device, which, as an external unit, is connected via a emulation port as a communication link with the target programmable unit for transferring emulation data and is configured to ascertain respective trace data from an emulation of the target programmable unit. The emulation device has at least one emulation controller and a storage device for trace data and/or an output device in connection with an external processing and display device. The target programmable unit is configured
to transfer, in a defined relationship with a CPU clock signal of the target programmable unit, the following emulation data through the communication link to the emulation device (4):
data read by the CPU from a data bus of the target programmable unit,
those external events that have an influence on the program counter,
optionally, periodically created complete or partial copies of the register memory, and
optionally, one or more data type signals; and
to transfer the CPU clock signal from the target programmable unit to the emulation device.

The advantages of the apparatus of the second aspect of the invention correspond to those explained before for the method of the first aspect of the invention. Since explanations and advantages have mostly already been discussed in the context of the method of the invention, the following description is kept short and focuses on the features of the different embodiments. As before, a combination of the embodiments is possible, unless stated otherwise explicitly.

In one embodiment the target programmable unit is configured to transfer exclusively the following emulation data to the emulation device:
data read by the CPU from a data bus of the target programmable unit,
those external events that have an influence on the program counter,
optionally, periodically created complete or partial copies of the register memory, and,
optionally, one or more data type signals.

In one embodiment the emulation controller of the target programmable unit is configured to transfer a data type signal as a part of the emulation data to the emulation port and, if present, to a buffer memory of the target programmable unit for temporary storage.

In another embodiment, the target programmable unit and the emulation device are configured to provide bi-directional communication between the target programmable unit and the emulation device. Preferably, the emulation device has a debugging interface, such as a JTAG interface. The debugging interface can be a JTAG interface, which, in a preferred embodiment is integrated into the emulation port such that the JTAG interface and the emulation port share the same contact pins.

The apparatus preferably provides for transfer of emulation data on the emulation port by means of a selection switch circuit, which, for example, can be implemented as a multiplexer. A buffer memory can still be connected to this selection switch circuit and can, for example, be implemented as a FIFO (First In-First Out) memory. There is also the possibility of transferring the emulation data, at least partially, directly out to the emulation device.

Controlling the selection switch circuit, the preparation of at least the CPU clock signal and/or the data read from the data bus, the events that have influence on the program counter, such as interrupts that has occurred and/or events that stop the CPU and/or events that trigger a data transfer bypassing the CPU (DMA transfer) and/or the register bank copy and/or a indicative of a data type are handled by an emulation controller on the side of the target programmable unit.

In a further embodiment, the emulation device has a program memory corresponding with the program memory of the target programmable unit. That means, the program memory of the emulation device is functionally equivalent to the program memory of the target programmable unit. In one embodiment, the program memory of the emulation device is an identical replication of the program memory of the target programmable unit.

In another embodiment, the target programmable unit is configured to transmit its CPU clock signal through the emulation port to the emulation device (4).

An emulation device, as a real-time emulation unit, preferably has a logic module in the form of a bond-out chip or of a programmable logic module. The corresponding emulation device is implemented as an external unit that is connected with the programmable unit via a emulation port as the communication link. The emulation device has at least one emulation control device of its own.

The first implementation example shows the capability to perform emulation of the CPU offline using emulation data that have previously been acquired from the programmable unit and stored. The simulation of the CPU behavior can in this case be achieved to great advantage using a software program which, for example, runs on a processing and display device such as a personal computer, as part of the emulation device. Corresponding trace data are ascertained by this emulation and, for example, stored and/or output to another external unit. In order to define a certain time-allocation for emulation data that is transferred to the emulation device via the emulation port, the CPU clock signal can count in the ED in a suitable counter device. This type of allocation of a point in time is referred to as a time-stamp.

It is possible that the emulation data transmitted from the programmable unit is stored in a memory in the emulation device, such as a RAM, a hard disk or similar apparatus. This data can be with or without time-stamp.

In a further embodiment, digital outputs of the emulation device are switchable outputs. Signals of the digital outputs can be fed back via a corresponding connection to the target programmable unit. Specifically, one or more pins of the emulation port can also be used as output pins by controlling a related control register via the emulation and giving the emulation device access to the output pin. If necessary, the output signals of these pins can be transferred via a ribbon cable, etc., back to near the programmable unit. In case the emulation is not active, the emulation port can be connected directly to the network of the output signals with a jumper or similar apparatus.

In another implementation example of the invention, it is possible, besides performing real-time CPU emulation to perform a real-time emulation in particular for internal and external write and read memory (herein also referred to as RAM) of the programmable unit. An address bus line in the target programmable unit is then preferably connected with the emulation controller of the target programmable unit via an address comparator. This address comparator indicates to the PU emulation controller device whether read data is from an address area which is also accessed in write mode by function units other than function units contained in the real-time emulation. In this case, it is possible that the address range to be evaluated in the address comparator is permanently programmed, e.g. for I/O ranges that are hard-wired in the PU or that can be freely configured, for example for external memory such as a dual-ported RAM. The emulation data additionally contains only read data from storage areas which are changed in a non-exclusive manner by the CPU (and thus possibly also by other entities), such as I/O areas, dual ported RAM etc. Furthermore, it is advantageous in this context if the respective emulation device includes other function units of the programmable unit in addition to the CPU, namely, function units which are capable of accessing the respective memory in write mode. These function units are other CPUs and/or one or more DMA units and/or one or more memory management units (MMU) or similar apparatus.

Particularly for real-time emulations, an emulation device having a debug interface is also advantageous.

Moreover, there remains the possibility of having the application program executing in the programmable unit use the pins occupied by the emulation port. Appropriate control registers which control one or more digital outputs of the emulation device can be implemented in the emulation device at the address of the control registers, which control one or more pins occupied by the emulation port during the debugging process. If the real-time emulation accesses this control register in write mode, the behavior of the pins is the same as their corresponding pins in the programmable unit. The pins can also be operated as inputs and outputs by the peripheral units (such as pulse-width modulators, display drivers, etc.) copied in the emulation device. The peripheral units are controlled by the control register.

According to a third aspect of the present invention a target programmable unit is provided, which has at least one CPU and an emulation port as a communication link for transferring emulation data to an external emulation device. The target programmable unit is configured
to provide at the emulation port, in a defined relationship with a CPU clock signal (8) of the target programmable unit (1), the following emulation data for transfer through the communication link (5) to the emulation device (4):
   data read by the CPU from a data bus of the target programmable unit,
   those external events that have an influence on the program counter,
   optionally, periodically created complete or partial copies of the register memory, and,
optionally, one or more data type signals; and
to provide the CPU clock signal from the target programmable unit as an output for transfer to the emulation device (4).

Embodiments of the target programmable unit have been described in the context of embodiments of the apparatus of the second aspect of the invention, and also correspond to embodiments of the method of the first aspect of the invention.

According to a fourth aspect of the invention, an emulation device is provided, which comprises
an emulation port (15) for communication with an external target programmable unit (1) for receiving emulation data,
a program memory for storing program code functionally identical to that stored in the external target programmable unit;
a storage device (11) for trace data and/or an output device in connection with an external processing and display device (28),
   wherein the emulation port is configured to receive in a defined relationship with a CPU clock signal of the target programmable unit the following emulation data:
data read by a CPU of the external target programmable unit from a data bus of the target programmable unit,
those external events that have an influence on the program counter,
   optionally, periodically created complete or partial copies of the register memory, and,
   optionally, one or more data type signals;
      and to receive a CPU clock signal from the target programmable unit,
      and wherein the emulation device is further configured to emulate the external target programmable unit (1) using the transferred emulation data and program code stored in the program memory, to ascertain respective trace data from the emulation to store and/or the output the trace data.

Embodiments of the emulation device of the fourth aspect of the invention have been described in the context of embodiments of the apparatus of the second aspect of the invention, and also correspond to embodiments of the method of the first aspect of the invention.

A fifth aspect of the invention is formed by a method for emulation of a target programmable unit, which has at least one CPU, by means of an external emulation device, which is coupled to the target programmable unit by means of a communication link, the method comprising the following steps:
Transferring predetermined initialization data through the communication link to the emulation device, with which initialization data the target programmable unit has initialized itself and/or has been initialized, for initializing the emulation;
Transferring through the communication link to the emulation device, a signal, which allows to derive the original CPU clock signal of the target programmable unit, and, in a defined relationship with the CPU clock signal (8) emulation data, which are formed by those data, which cannot be calculated on the basis of a given model of the target programmable unit and on the basis of the program code,
Emulating the target programmable unit in the external emulation device using the transferred emulation data;
Ascertaining respective trace data from the emulation; and
Storing and/or the outputting the trace data.

### BRIEF DESCRIPTION OF THE DRAWINGS

In the following section, advantageous implementation examples of the invention are explained in more detail by means of the figures.

FIG. 1 is a block diagram of the procedure and device for emulating a programmable unit for offline emulation according to the invention;

FIG. 2 is a block diagram of an embodiment of an offline emulation implementation without RAM emulation;

FIG. 3 is a block diagram analogous to FIG. 2 of a real-time emulation without RAM emulation.

FIG. 4 is a block diagram analogous to FIG. 3 of a real-time emulation with RAM emulation.

FIG. 5 is a block diagram analogous to FIG. 4 of a real-time emulation with RAM emulation and debugging support.

FIG. 6 is a block diagram analogous to FIG. 5 for a real-time emulation with the capability of allowing the application program to use the I/O pins used by the emulation port.

### DETAILED DESCRIPTION

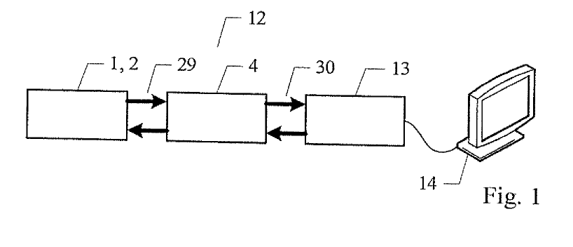

FIG. 1 is a block diagram of a device 12 according to the invention, showing in particular how data 29 is exchanged between a PU 1 and an emulation device, ED, 4 and which transfers data 30 is transferred between an ED 4 and an evaluation software program 13, both in conformity with the invention.

Data 29 transferred between PU 1 and ED 4 contains complete or limited sets of the following data: data read from the CPU; events that occurred; copies of the register memory content or individual register banks; information concerning the currently transferred data type, events, states and similar items, see also the above described initialization data and emulation data. Furthermore, a CPU clock signal is transferred.

The transfer of the data 29 can be performed with the CPU 2 of PU 1 running or suspended.

The transferred emulation data are used as input data of an emulation in an ED 4, which created a partial or complete set of trace data, which is made available via a communication path 30 to an evaluation software program 13 or similar program.

The evaluation software program 13 can visualize the trace data and, for example, display on a monitor 14.

In particular, a debugger software program can control the ED so that the communication path 30 can be established bi-directionally.

The ED can also control the PU in particular so that the communication path 29 can also be established bi-directionally.

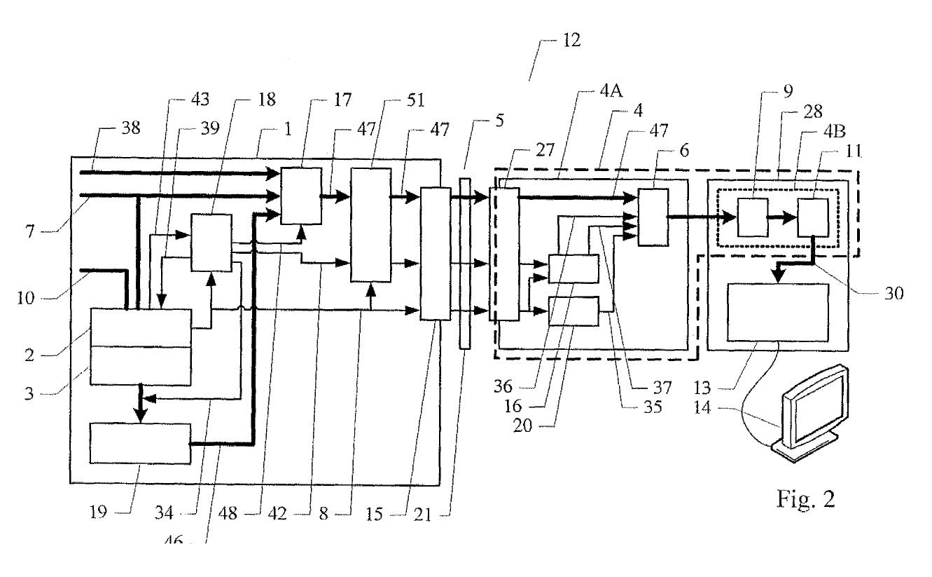

FIG. 2 shows a first implementation example of the device 12 according to the invention for emulating the programmable unit 1 with which the emulation is performed offline without RAM emulation. The emulation is not run simultaneously with program execution in the CPU 2 of PU 1, but instead is delayed within a processing and display device 28.

According to the invention, PU 1 has a PU emulation controller 18, a register memory copy 19, a selection switch circuit 17 with a connected buffer memory 51 in particular and a emulation port 15 as extensions.

As shown in FIG. 2, the programmable unit 1 has a register memory 3 as part of a CPU 2. The register memory copy 19 is a complete or partial copy of this register memory 3. To attain this reproduction, strobe information 34 is output from the PU emulation controller 18. The time-point for copying the content of the register memory into the register memory copy must be made known to the ED, for example by means of a certain coding of the data type signal 42.

Different information 43 such as occurring interrupts and/or data accesses are transferred from the CPU 2 to a PU emulation controller 18. On the other side, this is connected with the CPU by means of a breakpoint signal 39. The CPU 2 is still connected with an address bus 10.

The selection switch circuit 17 is connected to a line or a bus 46 for transferring the register memory copy 19 as well as to other buses for transferring number and/or level of an interrupt 38, with a data bus 7 or with similar items. The selection switch circuit 17 is controlled by the PU emulation controller 18 by means of a data selection line 48 during which the data selection line 48 indicates the data source as well as the data source's bus width to the selection switch circuit 17.

Preferentially, the PU emulation controller 18 controls the selection switch circuit 17 in such a way that interrupts 38 with a priority higher than the data read by is data bus 7 from the CPU 2 are transferred. If no interrupts 38 and/or read data are ready for transfer, the register memory copy 19 can be transferred with lowest priority.

Note that the identification or the differentiation of the respective lines or signal paths in the following is normally handled by the transferring data so that reference is made only to data 7 instead of to data bus 7.

The selection switch circuit 17 is connected with the emulation port 15 via a data line 47. Buffer memory 51, which is organized as FIFO for example, is switched between the selection switch circuit 17 and the emulation port 15.

A CPU clock signal 8 is sent from the CPU to the PU emulation controller 18, to the buffer memory 51 and via the emulation port 15 to the ED 4. In a certain relationship to this CPU clock signal, the PU can transfer the data present at the output of the selection switch circuit 17 or the buffer memory 51, via the emulation port 15, to the emulation device 4 via a communication connection 5, whereby the ED 4 has at least one corresponding emulator input 27.

Moreover, a data type signal 42 is also output from the PU emulation controller 18 to the emulation port 15 with this data type signal 42 also capable of being stored temporarily by means of buffer memory 51.

It is also possible to switch emulation port 15 so it acts as a normal I/O port with no connection to ED 4, for example by setting special mode pins or setting a bit in a control register of the CPU.

The respective data is at least transferred through the emulation port 15 to the emulator input 27 via the communication connection 5, such as a serializing/deserializing, low voltage differential point-to-point connection 21 (LVDS serdes).

The ED 4 is divided into two units in case of an offline emulation: one data entry unit 4A and an emulation unit 4B, whereby the emulation unit 4B is implemented in a PC as an external processing and display device 28.

The signals captured by emulator input 27, such as the CPU clock signal 8 and the data type signal 42 in particular, can be fed into an ED emulation controller 16, for example. The ED 4 has a counter 20, through which the CPU clock signals 8 are counted so that a time allocation, the so-called time stamp 35, is available to all data that is read in via the emulator input 27.

The corresponding data read in through the emulator input 27 is provided with a time stamp if required, stored in a memory 6, which can for example be implemented as RAM, hard-disk, etc.

Data type 36 and write information 37 are transferred from ED emulation controller 16 to the memory 6. The corresponding time stamp 35 is transferred from counter 20 to the memory 6.

The data entered in memory 6 is transferred to emulation unit 4B, which reproduces the behavior of the PU's CPU and creates a complete or partial set of trace data. In order to do this, the data found in memory 6 is transferred to an offline emulation unit 9, which is implemented as a software program in the PC 28. The trace data gathered by the offline emulation unit 9 is stored for example in a trace data memory 11, which is also referred to as a storage device of the emulation device herein, and can be transferred to an evaluation software program 13 via connection 30. This evaluation software program 13 can visualize, for example, the results of the debugging process on a monitor 14.

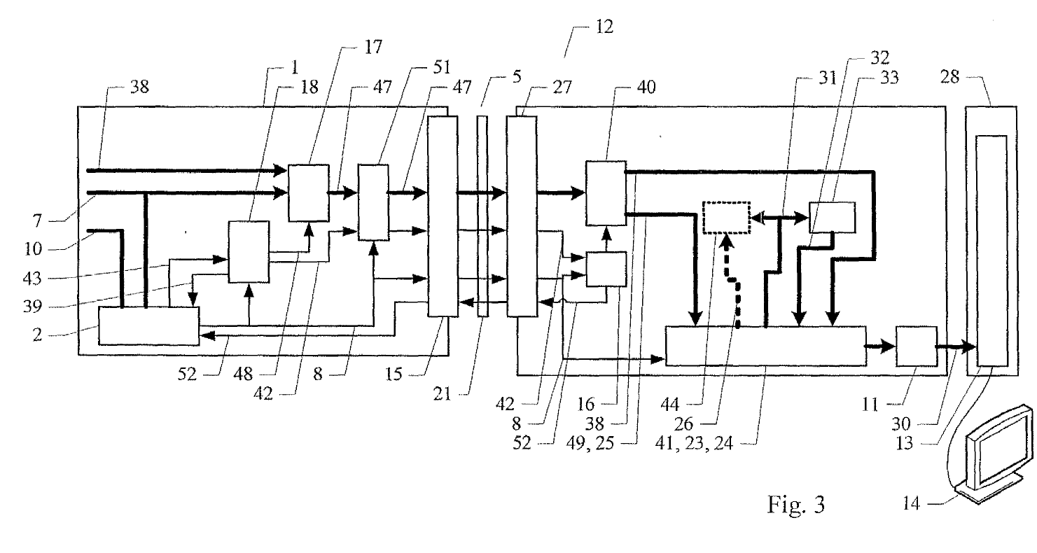

A second implementation example of the device 12 in accordance with the invention is shown in FIG. 3, whereby a real-time emulation is performed with this implementation example. At the same, a register memory copy 19 (see FIG. 2) is no longer required so that the PU can be structured more simply and inexpensively.

In this implementation example, the CPU 2 in particular can be stopped by a breakpoint signal 39 created and output by the PU emulation controller 18 and/or a breakpoint signal 52 created and output from the ED emulation controller 16.

In addition to dispensing with the register memory copy 19, it is also no longer necessary to output the strobe information 34 from the PU emulation controller 18 and to implement a line or a bus 46 for transferring the register memory copy 19, see FIG. 2.

In the ED 4, the behavior of the CPU 2 of the PU 1 is reproduced with a real-time emulation unit 41, for example a programmable logic module 23 or a bond-out chip 24. In order to do this, the real-time emulation unit 41 is connected to a program memory 33 with an address bus 31 and a program data bus 32. The same program code as in the program memory of CPU 2 is located, especially partially or completely, in the program memory 33.

A CPU clock signal 8 is transferred by the CPU 2 via an emulator input 27 and via the respective communication connection 5 to the ED 4 and fed into the real-time emulation unit 41 there.

The ED emulation controller 16 uses the data type signal 42 received and/or a CPU clock signal 8 to control a demultiplexer 40, which makes, in particular, either the read data 49 of the CPU 2 or the interrupt numbers 38 occurring on the CPU 2 available to the real-time emulation unit 41.

The data bus of the real-time emulation unit 41 has write access (see connection 26) to a RAM 44. Since RAM 44 is not read in this implementation example, RAM 44 does not need to be implemented. Only the write data access 26 to the RAM 44 is required for generating a complete set of trace data.

Read access 25 to the data bus allows the real-time emulation unit 41 to receive the data to be read 49 from the demultiplexer 40.

The functionality of the CPU 2 is reproduced in the real-time emulation unit 41 and then the corresponding trace data is filtered either completely or according to certain criteria and stored in a trace data memory 11 or is output directly to an evaluation software program 13. This evaluation software program 13 runs preferentially in the processing and display unit 28, which can be a PC, for example, and visualizes the results of the debugging process on the monitor 14.

In the ED 4, the reproduction of the on-chip-peripheral of the PU can be partially dispensed with. Utilizing the programmable logic module, for instance, makes it possible to use a single ED to emulate a large number of various target CPUs of at least one microcontroller family. The relevant implementation of the real-time CPU emulation can be loaded into the programmable logic module 23.

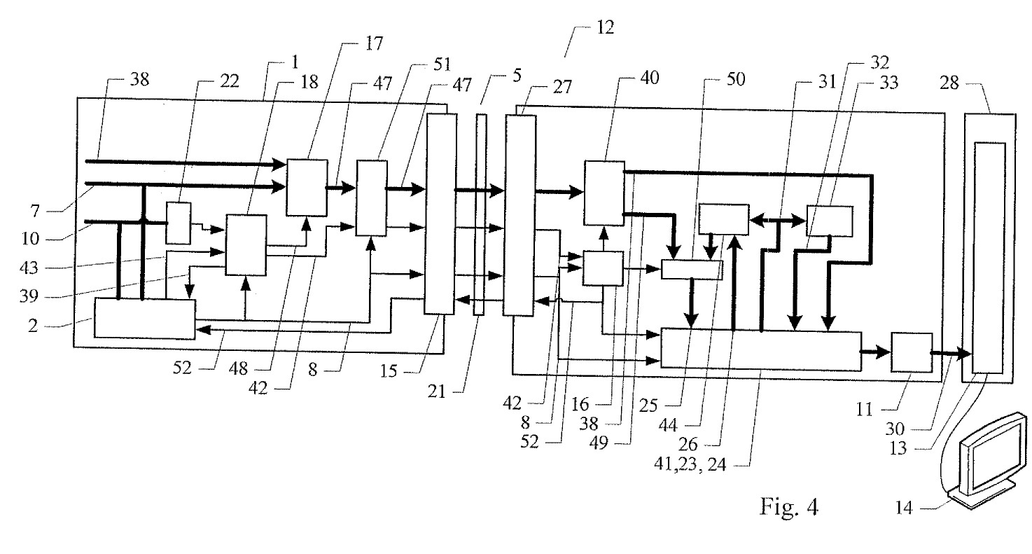

A third implementation example of the device 12 in accordance with the invention is shown in FIG. 4. This implementation example extends the implementation example shown in FIG. 3 by the ability to emulate the RAM of the PU 1 as well, and therefore to further reduce the amount of data required for the emulation and to be transferred between the PU 1 and the ED 4.

The relevant ED 4 will comprise all function units for the corresponding real-time emulation, which are capable of having write access to the memory, in particular to one or more CPUs and/or one or more DMA units and/or one or more MMU units.

In the case of a real-time emulation with RAM emulation, a representation of the RAM of the PU 1 is also transferred to the ED 4 initially as static information if the content of the RAM is not clearly predetermined by a reliable, explicit initialization or something similar. The RAM 44 of the ED 4 is initialized with this representation.

In the case of an online emulation with RAM emulation, the relevant structure of the PU of the device 12 in accordance with the invention differs from the structure shown in FIG. 3 as a result of an additional address comparator 22, which is connected between address bus 10 and PU emulation controller 18. The address comparator 22 shows whether the data currently read on the data bus 7 originates from an address range, to which the function units contained in the real-time emulation unit 41 of the ED have no write access either.

Data that is read from address ranges, to which only function units contained in the real-time emulation unit 41 have write access, no longer have to be transferred to the ED 4 in this implementation example. The relevant address ranges can be permanently programmed here and/or can be configured freely.

Moreover, the structure of the programmable unit 1 also corresponds with the device 12 described in connection with FIG. 3.

The ED 4 has in addition a data selector 50 in this implementation example, which determines a source for the data 25 that is read from the real-time emulation unit 41. If the data type signal 42 shows to the ED emulation controller 16 or if the emulation automatically detects that there should be read access to data located in an address range, to which only the function units contained in the real-time emulation unit 41 can have write access, then the ED emulation controller 16 switches the data selector 50 in such a way that the real-time emulation unit 41 reads data from the RAM 44 of the ED.

If the data type signal 42 shows to the ED emulation controller 16 or if the emulation automatically detects that there should be read access to data located in an address range, to which function units other than those contained in the real-time emulation unit 41 have write access, then the ED emulation controller 16 switches the data selector 50 in such a way that the real-time emulation unit 41 reads the data 49 received by the PU.

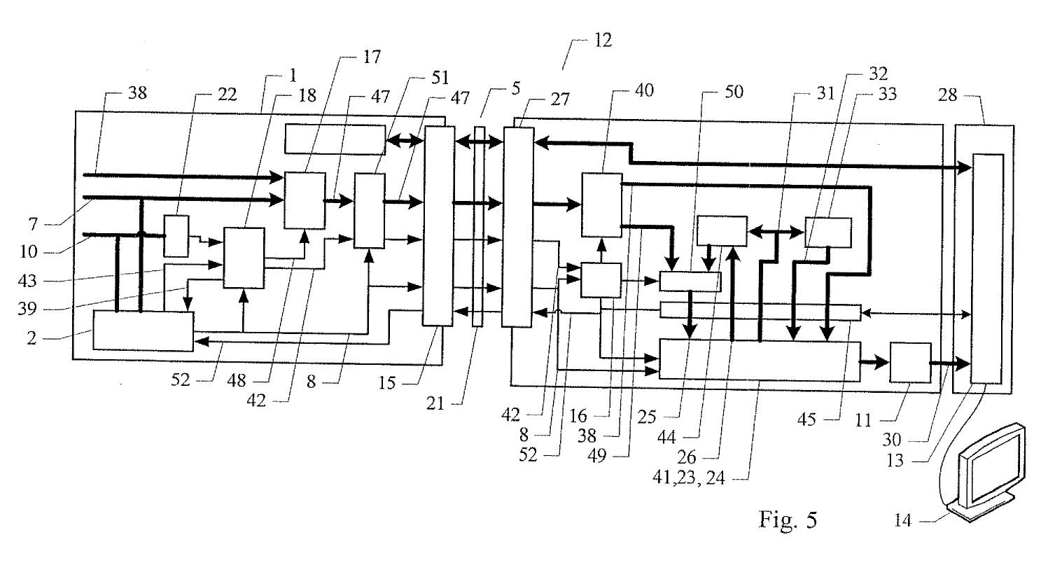

A fourth implementation example of the device 12 in accordance with the invention is shown in FIG. 5. This implementation example extends the implementation examples shown in FIG. 3 or in FIG. 4 by the ability to set complex breakpoints.

In line with the invention, it is possible to support certain breakpoints for interrupting the program execution in order to, for example, check certain values at the breakpoint of program execution. In addition to mechanisms possibly implemented on the target CPU for supporting these breakpoints, other mechanisms can be created by the emulation device 4 for supporting especially complex breakpoints. The emulation device can stop the CPU and access the address and data bus 10, 7 of the CPU 2.

The emulation device 4 has a debugging interface 45, which is used for detecting breakpoints and is controlled by the evaluation software program. If a valid breakpoint is detected, the CPU of the PU and the emulated CPU 23, 24 are stopped with a breakpoint signal 52.

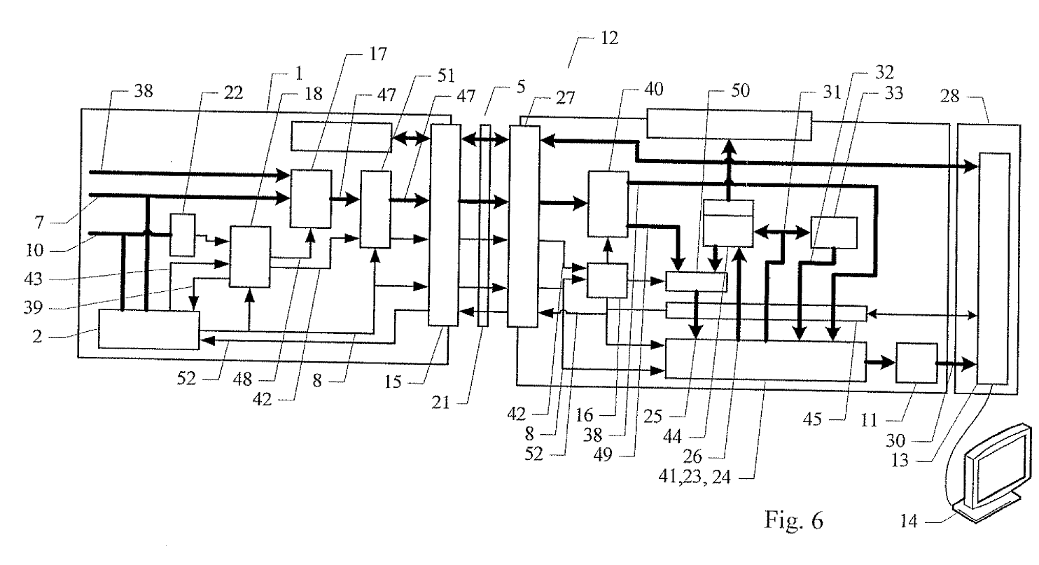

A fifth implementation example of the device 12 in accordance with the invention is shown in FIG. 6. In the case of this implementation example, the implementation examples shown in FIG. 3, FIG. 4 or in FIG. 5 are extended by the option of using the pins of the PU 1 occupied by the emulation port 15 by means of the application program executing in the PU 1.

Appropriate control registers 54, which control one or more digital outputs 55 of the ED 4, are implemented in the ED 4 at an address of the control registers, which control one or more pins occupied by the emulation port 15 during the debugging process. If the real-time emulation unit 41 has write access to this control register 54, the behavior of the ED pins 55 is the same as their corresponding PU pins.

The pins can 55 also be operated as inputs or combined inputs/outputs and in this case a data transmission for transferring the input signals of the pins 55 must be implemented on the CPU 2. This data transfer is not shown in FIG. 6 for the sake of simplicity.

The pins 55 can also be operated as inputs and outputs by the peripheral units (such as pulse-width modulators, display drivers, etc.) copied in the ED. The peripheral units are controlled by the control register 54.

It is possible to send back signals of the pins 55 to the PU via a ribbon cable, for example, and to feed these to a circuit board carrying the PU, close to the PU. Jumpers, or something similar, can be used to switch between the emulation port 15 and the pins 55.

If the emulation port 15 is used for communication with the ED, connected networks are controlled through the outputs 55. Jumpers, or something similar, can be used for disconnecting the connected network from the relevant pins of the emulation port 15. If the debugging process has been completed and the pins of the emulation port 15 are available to the PU, the connected networks can be connected directly to the pertinent pins of the emulation port 15. In order to do this, the emulation port 15 can be configured as a normal I/O port by setting special mode pins or a bit in a control register of the CPU, for example.

It should be noted that all other on-chip peripherals of the PU 1 have not been shown in FIGS. 2 to 6 for the sake of simplicity.

Time delays and a corresponding CPU clock offset can be caused by the transfer duration of data from the PU 1 and the ED 4, which has to be taken into consideration in the emulation and the evaluation of the trace data acquired. Especially when complex breakpoints are set, as described in the implementation example (see FIG. 5), a possible time offset has to be taken into consideration accordingly.

In all implementation examples for the invention, a decrease in the number of connections to the emulation port is possible if, for example, the transfer of pertinent data takes place when the edges of the CPU clock signal rise or fall, if the clock frequency is increased or if the data to be transferred is distributed over several CPU cycles and corresponding CPU wait cycles are inserted when the volume of data becomes too large.

In the following, the emulation port design will be explained for specific examples. It is noted that formulas given in this context do not apply generally for all design tasks, but are limited to the present examples.

Most actual microcontrollers provide a fast CPU and fast memory interface in combination with a significantly slower interface to I/O components. If the emulation port is operated with double data rate, based on the CPU clock, the amount of pins required to output the synchronization data can estimated as follows:

$$n = [ \frac{w + s}{2 * c} ] + 1$$

Here, n is the number of pins required, s is the number of status bits (target specific: interrupt state, bus wait flag, DMA state, DMA channel number), w is the bus width of I/O accesses and c is the minimum of clock cycles per CPU read instruction and clock cycles per DMA read operation.

To illustrate this formula, three typical examples are given in the following. The first example is a 8-bit microcontroller, for which we will also present the amount of additional hardware required to implement the emulation interface:

$$n = [ \frac{8 + 1}{2 * 4} ] + 1 = 3 ( 2 data , 1 clock )$$

The second example is that of a 16-bit microcontroller with additional DSP functionality:

$$n = [ \frac{16 + 6}{2 * 4} ] + 1 = 4 ( 3 data , 1 clock )$$

Finally, we present the example of a 32-bit microcontroller which uses only 16 bit for peripheral accesses:

$$n = [ \frac{16 + 6}{2 * 3} ] + 1 = 5 ( 4 data , 1 clock )$$

At higher CPU I/O read bandwidth the data stream to be transferred by the emulator interface may be buffered by a FIFO. In this case the statistical frequency of I/O load operations determines the actually required bandwidth. To make this statistical effect more clear, reference is made to table 1, which cites the statistical distribution of instruction types.

The required bandwidth is dependant on the instruction set and the size of the FIFO (among other not so dominant factors) and can be estimated by the following formula:

$$dr = \frac{f * lio * ( w + s )}{c}$$

here, dr is the data transmission rate from the programmable unit to the emulator, f is the CPU frequency, lio is the percentage of I/O load instructions and c is the min required cycles per load instruction.

The following to calculations are only provided as a frame of reference for required bandwidths. The first formula characterizes a 16-bit microcontroller at 60 MHz:

$$dr = \frac{60 Mhz * 5 \% * ( 16 Bit + 1 Bit )}{2} = 3 , 2 MByte / s$$

The second example characterizes a 32 bit microcontroller at 200 MHz:

$$dr = \frac{200 Mhz * 5 \% * ( 32 Bit + 2 Bit )}{1} = 42 , 5 MByte / s$$

These bandwidths are far below the data transmission rate, which would have to be available for an embedded trace module for extracting trace data continuously.

Of course, in a real implementation any case of FIFO overflow needs to be pre-vented by the following methods:
Automatic insertion of NOPs by the compiler in case of frequent I/O read accesses.
Pause the CPU in case of impending FIFO overflow.

The application EP 05 009 621, of which priority is claimed for the present application, is incorporated herein by reference in its entirety.

When interpreting the terms in the present application the following terms shall be construed as having the same meaning as the corresponding terms of the application EP 05 009 621 of the applicant, the priority of which is claimed for the present application.

| EP 05 009 621 | Present application |
|---|---|
| Emulationseinrichtung, EE | Emulation device |
| Programmierbare Einheit, PE, | Target Programmable Unit |
| Speichereinrichtung der | Trace data memory, Storage device of |
| Emulationseinrichtung | the emulation device |
| EE-Trace-Steuerung | emulation controller of the emulation |
| | device |
| Zielsystem | Target system |
| Registerspeicher | Register memory |
| RAM der PE | RAM |
| Vorrichtung zur Emulation | apparatus for emulation |

What is claimed is:

1. A method for emulation of a target programmable unit (1), which has at least one CPU (2), by means of an external emulation device (4), which is coupled to the target programmable unit by means of a communication link (5), the method comprising the following steps:
Transferring predetermined initialization data through the communication link (5) to the emulation device (4), with which initialization data the target programmable unit (1) has initialized itself and/or has been initialized, for initializing the emulation;
Transferring through the communication link to the emulation device, a CPU clock signal and, in a defined relationship with the CPU clock signal (8), the following emulation data:
data read by the CPU from a data bus of the target programmable unit,
those external events that have an influence on the program counter,
optionally, periodically created complete or partial copies of the register memory, and,
optionally, one or more data type signals;
Emulating the target programmable unit (1) in the external emulation device using the transferred emulation data;
Ascertaining respective trace data from the emulation in the external emulation device; and
Storing and/or the outputting the trace data.

2. The method of claim 1, wherein either the CPU clock signal (8) or a signal, which allows to derive the original CPU clock signal, is transmitted from the target programmable unit (1) through an emulation port (15) to the emulation device (4).

3. The method of claim 1, wherein in the step of transferring the emulation data comprises transferring exclusively:
data read by the CPU from a data bus of the target programmable unit,
those external events that have an influence on the program counter,
optionally, periodically created complete or partial copies of the register memory, and,
optionally, one or more data type signals.

4. The method of claim 1, wherein the emulation is performed as of receiving a quantity of data from the target programmable unit (1).

5. The method of claim 2, wherein the CPU clock signal (8) is transferred to an emulation controller (18) of the programmable unit and/or to a buffer memory (51) of the target programmable unit (1).

6. The method of claim 2, wherein the emulation data is transferred with either falling edges or rising edges of the CPU clock signal (8) or with falling as well as with rising edges of the CPU clock signal (8).

7. The method of claim 1, wherein a clock frequency driving the transfer of the emulation data is increased over the CPU clock frequency during transfer of the emulation data.

8. The method of claim 1, wherein the emulation data to be transferred is distributed over several cycles of the target CPU (2).

9. The method of claim 1, wherein insertion of CPU wait cycles is controlled by the target programmable unit or by the emulation device while the emulation data is being transferred.

10. The method of claim 1, wherein the target programmable unit (1) is switched to an operating mode for using an emulation port (15), which is configured as a part of the (1) communication link (5) of the target programmable unit, as a standard output port, the switching applying to either the whole emulation port or to a subset of pins of the emulation port.

11. The method of claim 10, wherein contact pins of the emulation port are used in shared operation with a JTAG interface.

12. The method of claim 1, wherein a partial or complete copy of a program memory and/or a partial or complete copy of a RAM of the target programmable unit (1) is transferred to the emulation device (4), provided the RAM has not been completely initialized at the beginning.

13. The method of claim 1, wherein the received emulation data is stored in a storage device (6) of the emulation device (4).

14. The method of claim 1, comprising a step of filtering the determined trace data before output and/or saving by means of the emulation device (4).

15. The method of claim 1, wherein the emulation of the target programmable unit (1) is performed offline by the emulation device using previously obtained and stored emulation data.

16. The method of claim 2, wherein the CPU clock signals (8) are counted in the emulation device (4) with a counting device (20) for assigning a certain point in time to the transferred emulation data.

17. The method of claim 15, wherein the emulation of the target programmable unit is performed without emulating a random access memory of the target programmable unit.

18. The method of claim 1, wherein the program execution of the target programmable unit (1) is simulated by the emulation device (4) for each respective context level beginning at the time of the last detected, complete copy of a register bank (3) of the same context.

19. The method of claim 15, wherein the CPU of the target programmable unit is emulated by means of a computer program, which is executed on a computer.

20. The method of claim 15, wherein the emulation of the target programmable unit includes emulating either a part of the RAM of the target programmable unit or the complete RAM of the target programmable unit.

21. The method of claim 1, comprising the steps
determining in the target programmable unit whether data currently read by the CPU or during a DMA operation originate from an address range of the target programmable unit that can be written to by function units other than the CPU of the target programmable unit (1), followed by
transfer of only those data read by the CPU or during a DMA operation to the emulation device (4), which originate from the address range of the target programmable unit that can be written to by function units other than the CPU of the target programmable unit (1).

22. The method of claim 21, wherein the address ranges that can be written to by function units other than the CPU of the target programmable unit are either permanently preprogrammed in a fixed way or configured freely or partly programmed permanently and partly configured freely.

23. The method of claim 1, wherein the emulation is performed in real time in the emulation device (4).

24. The method of claim 23, wherein, for performing the real-time emulation, a corresponding implementation of the CPU (2) of the target programmable unit (1) is loaded into a programmable logic module of the emulation device (4).

25. The method of claim 1, wherein the target programmable unit (1) or the CPU (2) of the target programmable unit is stopped by the emulation device (4) or by the target programmable unit (1) upon detecting a valid breakpoint.

26. The method of claim 1, wherein either one or more breakpoints are initiated and managed by the emulation device (4).

27. The method of claim 26, wherein a breakpoint signal (39, 52) is transferred from a emulation controller (18) of the target programmable unit or a emulation controller of the emulation device (16) to the CPU (2) of the target programmable unit (1).

28. The method of one of claim 23, wherein the emulation device (4) accesses the address bus and data bus (10, 7) of the target programmable unit (1) after stopping the target programmable unit.

29. The method of claim 23, wherein the emulation device, in a real-time emulation, has write and read access to its memory and, in case of a read access, receives the data transferred from the target programmable unit (1).

30. The method of claim 23, wherein, if an event is generated in the target programmable unit (1), the same event is triggered in the emulation device either simultaneously or with an offset.

31. The method of claim 1, wherein a data selector (50) of the emulation device (4) is switched to reading data from a memory device of the emulation device (4) or to reading data (49) of the target programmable unit (1).

32. The method of claim 23, wherein the real-time emulation of the target programmable unit is performed without emulating RAM of the target programmable unit.

33. The method of claim 32, wherein exclusively the following emulation data is transferred:
data read by the CPU from a data bus of the target programmable unit, and
those external events that have an influence on the program counter.

34. The method of claim 23, wherein the real-time emulation of the target programmable unit includes emulating either a part of or the complete RAM of the target programmable unit in real time.

35. The method of claim 23, wherein in a real-time emulation a complete or partial copy of at least one RAM of the target programmable unit (1) is also run in the emulation device (4).

36. The method of claim 35, wherein those function units of the target programmable unit are emulated, which write to the RAM of the target programmable unit (1).

37. The method of claim 1, wherein the emulation data is temporarily stored in a FIFO memory of the emulation controller of the target programmable unit, and wherein, in case a breakpoint is triggered in the emulation device with an offset, the emulation device continues the emulation using the emulation data stored in the FIFO memory up to the point, where the CPU of the target programmable unit was stopped by the emulation device.

38. An apparatus for emulation of a programmable unit, with
a target programmable unit (1), which has at least one CPU (2),
an emulation device (4), which, as an external unit (14), is connected via an emulation port (15) as a communication link (5) with the target programmable unit (1) for transferring emulation data, and is configured to ascertain respective trace data from an emulation of the target programmable unit,
wherein the emulation device (4) has at least one emulation controller (16) and a storage device (11) for trace data and/or an output device in connection with an external processing and display device (28), and
the target programmable unit is configured
to transfer, in a defined relationship with a CPU clock signal (8) of the target programmable unit (1), the following emulation data through the communication link (5) to the emulation device (4):
data read by the CPU from a data bus of the target programmable unit,
those external events that have an influence on the program counter,
optionally, periodically created complete or partial copies of the register memory, and,
optionally, one or more data type signals; and
to transfer the CPU clock signal from the target programmable unit to the emulation device (4).

39. The apparatus of claim 38, wherein the target programmable unit is configured to transfer exclusively the following emulation data to the emulation device (4):
data read by the CPU from a data bus of the target programmable unit,
those external events that have an influence on the program counter,
optionally, periodically created complete or partial copies of the register memory, and,
optionally, one or more data type signals.

40. The apparatus of claim 38, wherein the emulation controller (18) of the target programmable unit is configured to transfer a data type signal (42) as a part of the emulation data to the emulation port (15) and, if present, to a buffer memory (51) of the target programmable unit (1) for temporary storage.

41. The apparatus of claim 38, which is configured to provide bi-directional communication between the target programmable unit (1) and the emulation device (4).

42. The apparatus of claim 38, wherein the emulation device (4) has a debugging interface (25).

43. The apparatus of claim 38, wherein the emulation device (4) has a program memory (33) corresponding with the program memory of the target programmable unit (1).

44. The apparatus of claim 38, wherein the target programmable unit (1) is insertable with a emulation port (15) into a target system in place of a target programmable unit (1) without a emulation port, for debugging or emulation.

45. The apparatus of claim 38, wherein the emulation device (4) has a switchable data selector (50), which can be connected for reading out data from a RAM (44) of the emulation device (4) or for reading the data received from the target programmable unit (1).

46. The apparatus of claim 38, wherein the target programmable (1) unit is configured to transmit its CPU clock signal (8) through the emulation port (15) to the emulation device (4).

47. The apparatus of claim 38, wherein the emulation device (4), as a real-time emulation unit (41), has a logic module in the form of a bond-out chip or of a programmable logic module (23).

48. The apparatus of claim 47, wherein the emulation device, as the real-time emulation unit (41), is connected with an address bus (31) and/or the program memory (33) and/or a program data bus (32).

49. The apparatus of claim 38, wherein the emulation device (4) has a demultiplexing device (40).

50. The apparatus of claim 38, wherein the emulation device (4) has implemented control registers (54) which control one or more digital outputs (55) of the emulation device (4) and/or peripheral units copied from the target programmable unit (1) in the emulation device (4).

51. The apparatus of claim 38, wherein digital outputs (55) of the emulation device (4) are switchable as outputs, and wherein signals of the digital outputs (55) can be fed back via a corresponding connection to the target programmable unit (1).

52. The apparatus of claim 38, wherein an address bus line (20) in the target programmable unit (1) is connected with the emulation controller (18) of the target programmable unit via an address comparator (22).

53. The apparatus of claim 47, wherein the emulation device, as the real-time emulation unit (41), is connected with a RAM (44) via a data bus.

54. The apparatus of claim 38, wherein emulation port of the target programmable unit comprises a FIFO memory on its output side and wherein the emulation controller (18) is configured to transmit emulation data contained in the FIFO memory to the emulation device.

55. The apparatus of claim 38, wherein the emulation device comprises a time multiplexer, that has inputs connected to the emulation controller of the target programmable unit and to the random access memory of the emulation device, and an output connected with a CPU of the emulation device, and which is configured to provide signals, which have been received at its inputs, in the form of a time-multiplexed output signal.

56. The apparatus of claim 38, comprising a respective JTAG interface on the side of the target programmable unit and on the side of the emulation device.

57. A target programmable unit (1), which has at least one CPU (2), and an emulation port (15) as a communication link (5) for transferring emulation data to an external emulation device (1), wherein the target programmable unit is configured
to provide at the emulation port, in a defined relationship with a CPU clock signal (8) of the target programmable unit (1), the following emulation data for output through the communication link (5) to the emulation device (4):
data read by the CPU from a data bus of the target programmable unit,
those external events that have an influence on the program counter,
optionally, periodically created complete or partial copies of the register memory, and,
optionally, one or more data type signals; and
to provide the CPU clock signal from the target programmable unit as an output for transfer to the emulation device (4).

58. The target programmable unit of claim 57, which is configured to transfer exclusively the following emulation data to the emulation device (4):
data read by the CPU from a data bus of the target programmable unit,
those external events that have an influence on the program counter,
optionally, periodically created complete or partial copies of the register memory, and,
optionally, one or more data type signals.

59. The target programmable unit (1) of claim 57, which is configured to transfer the emulation data with either falling edges or rising edges of the CPU clock signal (8) or with falling as well as with rising edges of the CPU clock signal (8).

60. The target programmable unit (1) of claim 57, which is configured to generate a clock signal with a frequency that is increased over the CPU clock frequency for driving the transfer of the emulation data.

61. The target programmable unit (1) of claim 57, which is configured to distribute the emulation data to be transferred over several cycles of the target CPU (2).

62. The target programmable unit (1) of claim 57, which is configured to switch to an operating mode for using the emulation port (15) as a standard I/O port.

63. The target programmable unit (1) of claim 57, which is insertable with the emulation port (15) into a target system in place of a target programmable unit (1) without a emulation port, for debugging or emulation.

64. The target programmable unit (1) of claim 57, which is configured to transfer a partial or complete copy of a program memory and/or a partial or complete copy of a RAM of the target programmable unit (1) to the emulation device (4), provided the RAM has not been completely initialized at the beginning.

65. The target programmable unit (1) of claim 57, which is configured to
determine whether currently read emulation data originate from an address range of the RAM of the target programmable unit that can be written to by function units other than the CPU of the target programmable unit (1), and
transfer only those emulation data from the RAM to the emulation device (4), which originate from the address range of the RAM of the target programmable unit that can be written to by function units other than the CPU of the target programmable unit (1).

66. The target programmable unit of claim 57, comprising a emulation controller (18), which is configured to control the flow of emulation data through the emulation port.

67. The target programmable unit of claim 66, wherein the emulation controller (18) is configured to transfer a data type signal (42) to the emulation port (15) and, if present, to a buffer memory (51) of the target programmable unit (1) for temporary storage.

68. The target programmable unit of claim 57, which is configured to provide bi-directional communication between the target programmable unit (1) and the emulation device (4).

69. The target programmable unit of claim 57, which is configured to transmit its CPU clock signal (8) through the emulation port (15) to an emulation device (4).

70. The target programmable unit of claim 60, wherein an address bus line (20) in the target programmable unit (1) is connected with the emulation controller (18) via an address comparator (22).

71. The target programmable unit of claim 66, wherein the emulation controller (18) comprises a FIFO memory on its output side and is configured to continue transmitting emulation data contained in the FIFO memory to the emulation device after occurrence of a breakpoint, until the FIFO memory is empty.

72. The target programmable unit of claim 66, comprising a JTAG interface connected to the emulation controller (18), which is configured to provide JTAG output data according to the JTAG standard to the emulation port upon receiving an enabling signal from the emulation controller.

73. An emulation device, comprising
an emulation port (15) for communication with an external target programmable unit (1) for receiving emulation data,
a program memory for storing program code functionally identical to that stored in the external target programmable unit;
a storage device (11) for trace data and/or an output device in connection with an external processing and display device (28),
wherein the emulation port is configured to receive a CPU clock signal from the target programmable unit and to receive in a defined relationship with a CPU clock signal of the target programmable unit the following emulation data:
data read by a CPU of the external target programmable unit from a data bus of the target programmable unit,
those external events that have an influence on the program counter,
optionally, periodically created complete or partial copies of the register memory, and,
optionally, one or more data type signals;
and wherein the emulation device is further configured to emulate the external target programmable unit (1) using the transferred emulation data and program code stored in the program memory, to ascertain respective trace data from the emulation on the basis of the received emulation data, and to store and/or the output the trace data.

74. The emulation device of claim 73, which is further configured to ascertain the trace data from the emulation exclusively on the basis of the following received emulation data:
data read by a CPU of the external target programmable unit from a data bus of the target programmable unit,
those external events that have an influence on the program counter,
optionally, periodically created complete or partial copies of the register memory, and,
optionally, one or more data type signals.

75. The emulation device of claim 73, which has a debugging interface (25).

76. The emulation device of claim 73, wherein the emulation device (4) has a switchable data selector (50), which can be connected for reading out data from a RAM (44) of the emulation device (4) or for reading the emulation data received from the target programmable unit (1).

77. The emulation device of claim 73, wherein the emulation device (4), as a real-time emulation unit (41), has a logic module in the form of a bond-out chip or of a programmable logic module (23).

78. The emulation device of claim 77, wherein the emulation device, as the real-time emulation unit (41), is connected with an address bus (31) and/or the program memory (33) and/or a program data bus (32).

79. The emulation device of claim 73, which has a demultiplexing device (40).

80. The emulation device of claim 73, comprising implemented control registers (54) which control one or more digital outputs (55) of the emulation device (4) and/or peripheral units copied from the external target programmable unit (1) in the emulation device (4).

81. The emulation device of claim 73, wherein digital outputs (55) of the emulation device (4) are switchable as outputs, and wherein signals of the digital outputs (55) can be fed back via a corresponding connection to the target programmable unit (1).

82. The emulation device of claim 73, which, as a real-time emulation unit (41), is connected with a RAM (44) via a data bus.

83. The emulation device of claim 73, comprising a time multiplexer, that has inputs connected to the emulation controller of the target programmable unit and to the random access memory of the emulation device, and an output connected with a CPU of the emulation device, and which is configured to provide signals, which have been received at its inputs, in the form of a time-multiplexed output signal.

84. The emulation device of claim 73, comprising a JTAG-interface, which is shared with the emulation port.

85. A method for emulation of a target programmable unit (1), which has at least one CPU (2), by means of an external emulation device (4), which is coupled to the target programmable unit by means of a communication link (5), the method comprising the following steps:
Transferring predetermined initialization data through the communication link (5) to the emulation device (4), with which initialization data the target programmable unit (1) has initialized itself and/or has been initialized, for initializing the emulation;
Transferring through the communication link to the emulation device, a signal, which allows to derive the original CPU clock signal of the target programmable unit, and, in a defined relationship with the CPU clock signal (8) emulation data, which are formed by those data, which cannot be calculated on the basis of a given model of the target programmable unit and on the basis of the program code,
Emulating the target programmable unit (1) using the transferred emulation data;
Ascertaining respective trace data from the emulation; and
Storing and/or the outputting the trace data.
